(19) United States
(12) Patent Application Publication
(10) Pub. No.: US 2014/0293754 A1
(43) Pub. Date: Oct. 2, 2014

(54) WIRELESS SOUND WAVE COMMUNICATION SYSTEM AND METHOD

(71) Applicant: Nanosoft CO., LTD., Daejeon (KR)

(72) Inventor: Ji Su JANG, Daejeon (KR)

(73) Assignee: Nanosoft CO., LTD., Daejeon (KR)

(21) Appl. No.: 13/969,700

(22) Filed: Aug. 19, 2013

(30) Foreign Application Priority Data
Apr. 2, 2013 (KR) 10-2013-0036056

(51) Int. Cl. G08C 23/02

(52) U.S. Cl. CPC G08C 23/02
USPC 367/199

(57) ABSTRACT

Disclosed herein are a wireless sound wave communication system and method. The wireless sound wave communication system includes a transmitter and a receiver. The transmitter measures data or receives input data from an outside, converts the data into binary signals, and converts the binary signals into sound wave signals and then outputs the sound wave signals. The receiver identifies frequency information corresponding to the sound wave signals by receiving and analyzing the sound wave signals output from the transmitter, arranges the identified frequency information in time sequence, and analyzes the data based on areas that are extracted by the integration of the arranged frequency information. The sound wave signals that are output by the transmitter as the binary signals use different frequencies upon transmitting “0” and “1.”

### BACKGROUND OF THE INVENTION

1. Field of the Invention

The present invention relates generally to a wireless sound wave communication system, and more particularly to a wireless sound wave communication system in which a receiver receives and analyzes output sound wave signals.

2. Description of the Related Art

With the advancement of wireless communication technology, wireless networks, such as a mobile communication network, are dramatically attracting public interest. To keep up with this trend, technology that enables mobile terminals, such as mobile phones and smart phones, to perform wireless communication has been developed, and mobile terminals, such as mobile phones and smart phones, have been popularized and become necessities for people today. As wireless communication-enabled mobile terminals have been popularized as described above, the use of data based on wireless communication is rapidly increasing. However, systems for transmitting and receiving data over wireless communication networks impose a cost burden attributable to the use of a mobile communication network (e.g., a wideband code division multiple access (W-CDMA) network or a long-term evolution (LTE) network), and may incur the problem that communication speed may become slower or communication quality may deteriorate because of the use of a number of users. Recently, the disadvantages of high communication cost and low speed communication have been mitigated by utilizing wireless short-range communication. Current wireless short-range communication uses Bluetooth, ZigBee, and RF communication technologies. Of these wireless short-range communication technologies, Bluetooth and ZigBee require Bluetooth or ZigBee-enabled wireless short-range communication modules, thereby incurring an additional cost burden. Furthermore, even when a Bluetooth or ZigBee communication module is provided, the problem of setting a frequency range between devices in order to perform Bluetooth or ZigBee communication remains. In the case of RF communication, its use requires an antenna that enables frequency transmission and reception between devices. Furthermore, Bluetooth, ZigBee and RF wireless short-range communication modules incur the burden of power consumption.

Korean Patent Application Publication No. 10-2012-0045613 entitled “Data Transmission and Reception System and Method for Audio-Frequency Band Sound Wave Communication and Device applicable thereto,” and published on May 9, 2012 discloses technology, including a transmission device configured to receive information data to be transferred via an audio signal, to generate a pilot signal that is used to measure the phase delay of the audio signal, including the information data, attributable to a change in channel that may occur when the audio signal including the information data is transmitted, to generate a transmission target data frame to be carried on the audio signal by inserting the pilot signal into a data frame including the information data, to modulate the audio signal to impose the transmission target data frame thereon, and to output the resulting signal, and a reception device configured to receive the audio signal including the information data, and to extract the information data while reflecting the change in channel applied to the audio signal including the information data.

The above-described Korean patent application publication presents a data structure that transmits data over the original sounds of audio content via audio frequency band-based sound wave communication, thereby preventing information from being omitted. Although the technology disclosed in the above-described Korean patent application publication provides sound wave communication via the audio frequency band, a problem arises when this technology is used in daily life because it is difficult to accurately analyze sound waves because noise, such as ambient noise is added to a sound wave signal.

### SUMMARY OF THE INVENTION

Accordingly, the present invention has been made keeping in mind the above problems occurring in the prior art, and an object of the present invention is to provide a wireless sound wave communication system in which a transmitter outputs input data in the form of binary sound wave signals and a receiver receives and analyzes the output sound wave signals, thereby being able to transmit and receive data via sound wave signals.

Another object of the present invention is to provide a wireless sound wave communication system which, upon analyzing received sound wave signals, a receiver identifies the frequency information of the sound wave signals and recognizes data through the integration of the identified frequency information, thereby overcoming the problem of the reception of noise.

In accordance with an aspect of the present invention, there is provided a wireless sound wave communication system, including a transmitter configured to measure data or receive input data from the outside, to convert the data into binary signals, and to convert the binary signals into sound wave signals and then output the sound wave signals; and a receiver configured to identify frequency information corresponding to the sound wave signals by receiving and analyzing the sound wave signals output from the transmitter, to arrange the identified frequency information in time sequence, and to analyze the data based on areas that are extracted by integration of the arranged frequency information; wherein the sound wave signals that are output by the transmitter as the binary signals use different frequencies upon transmitting “0” and “1.”

The transmitter may transmit information representative of a preparation step and information representative of a start step using different frequencies so that the receiver can be notified of the preparation and start steps when receiving the sound wave signals.

When the receiver analyzes the sound wave signals output as the binary signals, the receiver may recognize the sound wave signals as binary bits, and the recognition of the bits may be performed in such a way that an integrated area in a normal state is set to a maximum value and a specific bit is recognized if each of the areas that are extracted by the integration of the frequency information corresponding to sound wave signals output as the binary signals is larger than the maximum value by a ratio equal to or higher than a predetermined ratio.

The transmitter may be a first terminal, and the receiver may be a first digital door lock; the first terminal may include a first reception unit configured to receive password information from the outside; a first analog-to-digital (A/D) converter configured to convert the password information received from the first reception unit into binary signals; a first sound wave output unit configured to generate and output sound wave signals corresponding to the binary signals; and a first storage unit configured to store the password information; the first digital door lock may include a first sound wave reception unit configured to receive the sound wave signals output from the terminal; a first identification unit configured to identify frequency information corresponding to the sound wave signals by analyzing the received sound wave signals; a first analysis unit configured to arrange the identified frequency information in time sequence, and to analyze data based on areas that are extracted by integration of the arranged frequency information; a second storage unit configured to store password information that is set as needed; a first comparison unit configured to compare the data analyzed by the first analysis unit with the password information stored in the second storage unit; a first opening and closing unit configured to include at least one means for opening a door if the data analyzed by the first analysis unit matches the password information stored in the second storage unit; and a first notification unit configured to include at least one notification means for notifying a user of an alarm if the data analyzed by the first analysis unit does not match the password information stored in the second storage unit; and the first terminal and the first digital door lock may form a digital locking system.

The digital locking system may include a hole formed through the door so that the sound wave signals generated by the terminal can be transmitted through the door, and a terminal rest formed the an outside of the door so that the terminal can be held therein.

The transmitter may be a second digital door lock, and the receiver may be a second terminal; the second digital door lock may include a second reception unit configured to receive password information from the outside; a second A/D converter configured to convert the password information received from the first reception unit into binary signals; a second sound wave output unit configured to generate and output sound wave signals corresponding to the binary signals; and a third storage unit configured to store the password information; the second terminal may include a second sound wave reception unit configured to receive the sound wave signals output from the second digital door lock; a second identification unit configured to identify frequency information corresponding to the sound wave signals by analyzing the received sound wave signals; a second analysis unit configured to arrange the identified frequency information in time sequence, and to analyze data based on areas that are extracted by integration of the arranged frequency information; a fourth storage unit configured to store password information that is set as needed; and a second comparison unit configured to compare the data analyzed by the second analysis unit with the password information stored in the fourth storage unit, and to generate an opening and closing information message including information about whether the data matches the password information; and the second digital door lock and the second terminal may form a digital locking system.

The second terminal further may include a first communication unit configured to transmit the opening and closing information message to an operating server over a communication network; and the second digital door lock further may include a second communication unit configured to receive the opening and closing information message from the operating server; a second opening and closing unit configured to include at least one means for opening a door if the opening and closing information message includes information indicating that the data matches the password information; and a second notification unit configured to include at least one notification means for notifying a user of an alarm if the opening and closing information message includes information indicating that the data does not match the password information.

The transmitter may be a health measurement apparatus, and the receiver may be a third terminal; the health measurement apparatus may include a measurement unit configured to include at least one sensor that measures health information; a third A/D converter to convert signals measured by the measurement unit into binary signals; and a third sound wave output unit configured to generate sound wave signals corresponding to the binary signals, and to output the sound wave signals; the third terminal may include a third sound wave reception unit configured to receive the sound wave signals from the health measurement apparatus; a third identification unit configured to identify frequency information corresponding to the received sound wave signals by analyzing the received sound wave signal; a third analysis unit configured to arrange the identified frequency information in time sequence, and to analyze the data based on areas that are extracted by integration of the arranged frequency information; and a display unit configured to include at least one means for displaying information that is analyzed by the third analysis unit; and the health measurement apparatus and the receiver may form a health measurement system.

In accordance with an aspect of the present invention, there is provided a wireless sound wave communication method, including measuring data or receiving input data from the outside; converting the data into binary signals; converting the binary signals into sound wave signals, and outputting the sound wave signals; receiving and recording the output sound wave signals; identifying frequency information corresponding to the stored sound wave signals by analyzing the received sound wave signals; arranging the identified frequency information in time sequence; extracting areas through the integration of the arranged frequency information; and analyzing the data based on the extracted areas.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a wireless sound wave communication system according to the present invention;

FIG. 2 is a diagram illustrating frequency information that is output by a transmitter;

FIG. 3 is a diagram illustrating a method by which a receiver according to the present invention analyzes specific data;

FIG. 4 is a diagram illustrating a digital locking system using the wireless sound wave communication system according to the present invention;

FIG. 5 is a diagram illustrating the configuration of a digital locking system according to a first embodiment of the present invention;

FIG. 6 is a diagram illustrating the configuration of a digital locking system according to a second embodiment of the present invention;

FIG. 7 is a diagram illustrating the configuration of a health measurement system using the wireless sound wave communication system according to the present invention; and

FIG. 8 is a flowchart illustrating a wireless sound wave communication method according to the present invention.

### DESCRIPTION OF THE PREFERRED EMBODIMENTS

Preferred embodiments of the present invention will be described in detail below with reference to the accompanying drawings. In the following description of the embodiments of the present invention, detailed descriptions of related well-known technology will be omitted if it is determined that they may unnecessarily obscure the gist of the present invention.

First, sound wave signals that are presented by the present invention may be communicated over a mixture of two frequencies in the range of 600 Hz to 1600 Hz in the same manner as Dual Tone Multi Frequency (DTMF) signals, or over a high frequency in the range of 1600 Hz to 2000 Hz. Furthermore, the present invention may use an audio frequency in the range of 20 Hz to 20 KHz, or a frequency equal to or lower than 20 Hz or equal to or higher than 20 KHz.

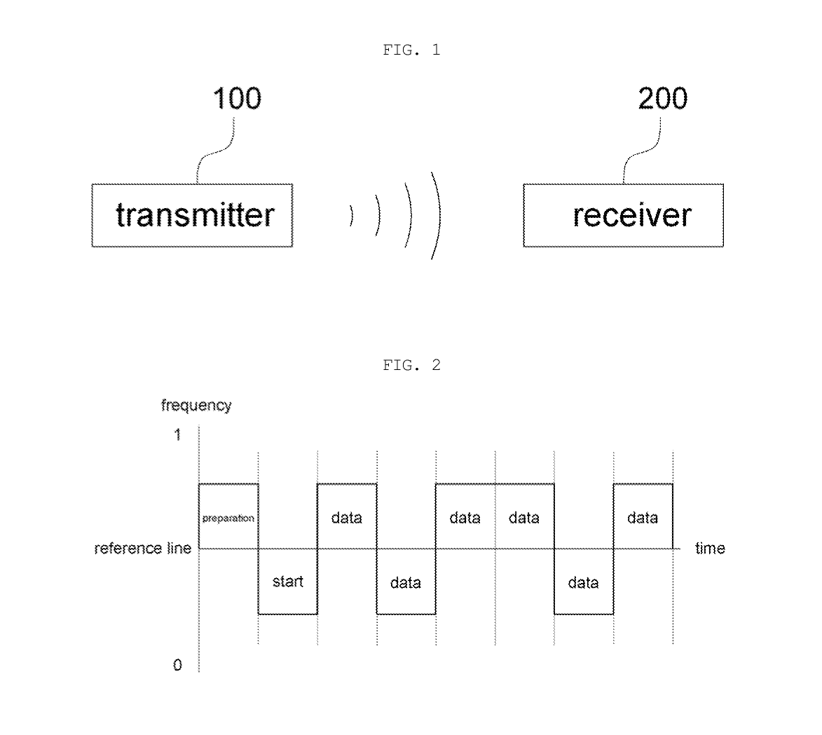

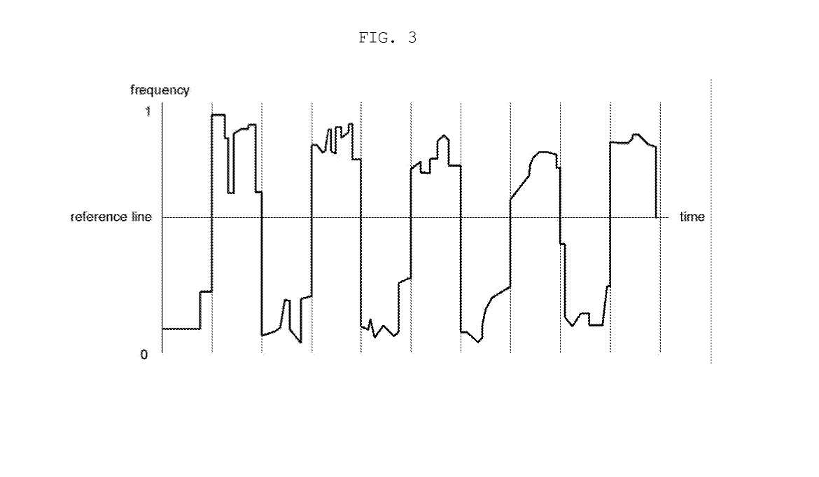

A wireless sound wave communication system according to a preferred embodiment of the present invention will be described with reference to FIGS. 1 to 3. FIG. 1 is a diagram illustrating the configuration of the wireless sound wave communication system. FIG. 2 is a diagram illustrating frequency information that is output by a transmitter 100. FIG. 3 is a diagram illustrating a method by which a receiver 200 analyzes specific data.

First, referring to FIG. 1, the wireless sound wave communication system may include the transmitter 100 and the receiver 200.

The transmitter 100 measures data or receives data from the outside, converts the data into binary signals, and outputs the binary signals in the form of sound wave signals. In this case, in order to measure data, data can be measured using a device that is capable of measuring health information. Accordingly, the transmitter 100 may be a health measurement apparatus, that is, a body measurement apparatus, such as weight scales, a height measurement apparatus, body fat scales, an obesity measurement apparatus, or a general body measurement apparatus; a biometric apparatus, such as a cardiotachometer, a blood pressure gauge, a blood glucose meter, or a bodily balance checking apparatus; or exercise equipment, such as a treadmill, an exercise bike, dumbbells, or a chest expander. Alternatively, the data can be received through a user's push or touch manipulation. A means for receiving data may be formed of a touch panel, or a keyboard. In this case, the means that receives data is not limited to only a touch panel or a keyboard, but may be any device capable of receiving data from the outside, for example, a keypad. If the touch panel forms a mutual layer structure along with a display function, it may be referred to as a “touch screen.”

The sound wave signals output in the form of binary signals include a predetermined frequency corresponding to “1” and another predetermined frequency corresponding to “0” in order to represent data information composed of “0” and “1.”Accordingly, the transmitter 100 uses a predetermined frequency to transmit “0,” and uses another predetermined frequency to transmit “1.” For example, when a frequency representative of “0” is set to 17 KHz and a frequency representative of 1 is set to 18 KHz, sound wave signals including respective pieces of frequency information, that is, 17 KHz, 18 KHz, 17 KHz, and 17 KHz, are sequentially output in order to output binary information “1011” in the form of sound wave signals. In this case, the sound wave signals are uniformly output at intervals that are set by the user.

Furthermore, the transmitter 100 uses the predetermined frequency representative of a preparation step and the other predetermined frequency representative of a start step.

Referring to FIG. 2, the sound wave signals include pieces of frequency information representative of preparation, start, data, and termination, respectively. This enables the receiver 200 to determine the accurate time at which it starts to analyze data based on the preparation and start steps through after receiving sound wave signals and before analyzing the sound wave signals. Furthermore, the receiver 200 can determine the time at which it finishes analyzing the data based on the termination step. Based on this, the receiver 200 receives the frequency representative of the preparation step first, and then receives the other frequency representative of the start step. Once the frequency information of the preparation and start steps has been received, the frequencies representative of data are received. Once the frequencies representative of data have been received, the frequency representative of the termination step is received. In this case, the frequency of the preparation step is a frequency signal that has the same meaning as a preparation command. The frequency of the start step is frequency information that accurately specifies the time at which data starts to be analyzed. For example, if the frequency of the preparation step is 17 KHz and the frequency of the start step is 18 KHz, the transmitter 100 outputs a frequency of 17 KHz first, and then outputs a frequency of 18 KHz. In this case, if the output duration of the frequency information of the preparation step is 500 msec and the output duration of the frequency information of the start step is 50 msec, the frequency of 17 KHz is output for 500 msec, and the frequency of 18 KHz is output for 50 msec. This causes the receiver 200 to receive the frequency of 17 KHz output for 500 msec, and then receives a frequency of 18 KHz output for 50 msec. Frequency information that is received after the frequencies of the preparation and start steps have been received is identified as data information, and is then analyzed. In this case, the frequencies of the preparation and start steps are not limited to 17 KHz and 18 KHz, respectively, and the output durations are not limited to 500 msec and 50 msec, respectively. This means that the frequency information and output durations may be set by a user as needed. As described above, the frequency of the start step enables an accurate start time to be identified, and the frequency of the preparation step provides the time for which the receiver 200 can enter a state in which sound wave signals can be received. It is preferred that the frequency of the start step and the frequency of the preparation step are different from each other. If the frequency of the start step and the frequency of the preparation step are the same, the start and preparation steps cannot be distinguished from each other.

The frequency of the termination step is frequency information that enables the end of the frequency signal to be accurately identified. In this case, the frequency of the termination step is a silent signal that does not include specific frequency information. For example, if the frequency of the preparation step is 17 KHz, the frequency of the start step is 18 KHz and the frequencies of the data are 17 KHz, 18 KHz, 17 KHz, and 18 KHz, the transmitter 100 outputs a frequency of 17 KHz first, and then outputs a frequency of 18 KHz. In this case, if the frequency output duration of the preparation step is 500 msec and the frequency output duration of the start step is 50 msec, the frequency of 17 KHz is output for 500 msec, and the frequency of 18 KHz is output for 50 msec. Once the frequencies of the preparation and start steps have been output as described above, 17 KHz, 18 KHz, 17 KHz, and 18 KHz (that is, the frequencies of data) are sequentially output. In this case, if the duration of the frequency output of data is 50 msec, each of 17 KHz, 18 KHz, 17 KHz, and 18 KHz is output for 50 msec. Once the frequencies of the data have been output, a silent state is maintained for the time that is set by a user as needed. If the time set as needed is two seconds, the transmitter outputs no frequency information for two seconds. For the termination step, a frequency that is different from the frequencies used for the preparation and start steps, other than a silent state, may be used. The receiver is enabled to accurately identify the region of data to be recorded and analyzed by setting the frequencies of the start and termination steps. Furthermore, the individual frequencies are enabled to be accurately identified by assigning different pieces of frequency information to the preparation step, the start step, the data, and the termination step.

The receiver 200 receives and analyzes the sound wave signals output from the transmitter 100, and identifies frequency information corresponding to the sound wave signals. Furthermore, the receiver 200 arranges the identified frequency information in time sequence, and analyzes the data based on areas that are extracted by the integration of the arranged frequency information. When the receiver 200 analyzes specific data based on the extracted areas, the specific data is recognized as binary bits, and the recognition of a bit is performed in such a way that an integrated area in a normal state is set to a maximum value and a specific bit is recognized when the integrated area of the specific data is larger than the integrated area in a normal state by a ratio equal to or higher than a predetermined ratio. The data may be analyzed by converting the recognized feature bits into numerical values.

Referring to FIG. 3, it can be seen that sound wave signals are recognized as the binary bits “0” and “1” based on a reference line. Furthermore, the frequency information is arranged in time sequence, and is plotted in a time-frequency plane. In this case, if the intervals at which sound wave signals are output are set to 50 msec, the frequency information is divided by the intervals of 50 msec. When “1” and “0” are recognized based on binary sound wave signals, data is recognized as “1” when the area of a region corresponding to “1” (in FIG. 3, a portion above reference line) is larger than an integrated area in a normal state by a ratio equal to or higher than a predetermined ratio. In contrast, data is recognized as “0” when the area of a region corresponding to “0” (in FIG. 3, a portion below the reference line) is larger than the integrated area in a normal state by a ratio equal to or higher than the predetermined ratio. As described above, data is identified when an area in question is larger than an integrated area in a normal state by the predetermined ratio normal state, and thus data can be analyzed with high accuracy even when sound wave (sound) signals are transmitted along with background noise (a human conversation, vehicle noise, ambient noise, or the like). In this case, the predetermined ratio may be 50% of an area in a normal state, or may be set by the user as needed. As illustrated in FIG. 3, when the receiver 200 receives frequencies including data including 1, 0, 1, 0, 1, 0, 1, 0, 1, 0, the received frequency information is integrated. In this case, even when each of the integrated areas of the frequency information does not fill 100% of the integrated area in a normal state, the data can be recognized as 1010101010. If both areas of the data “1” and the data “0” are larger than the reference area by a ratio equal to or higher than the predetermined ratio, the signal of a larger area may be recognized as data by the comparison between the areas.

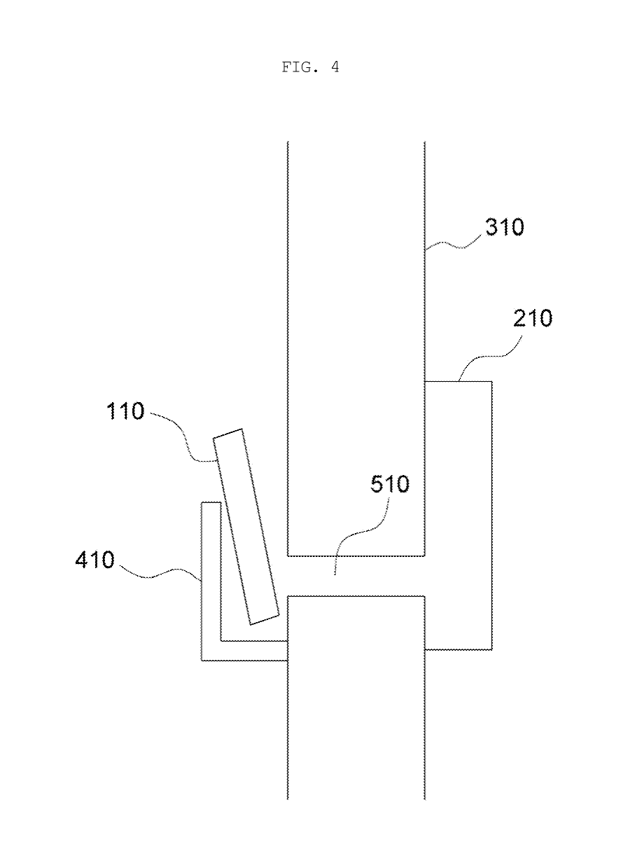

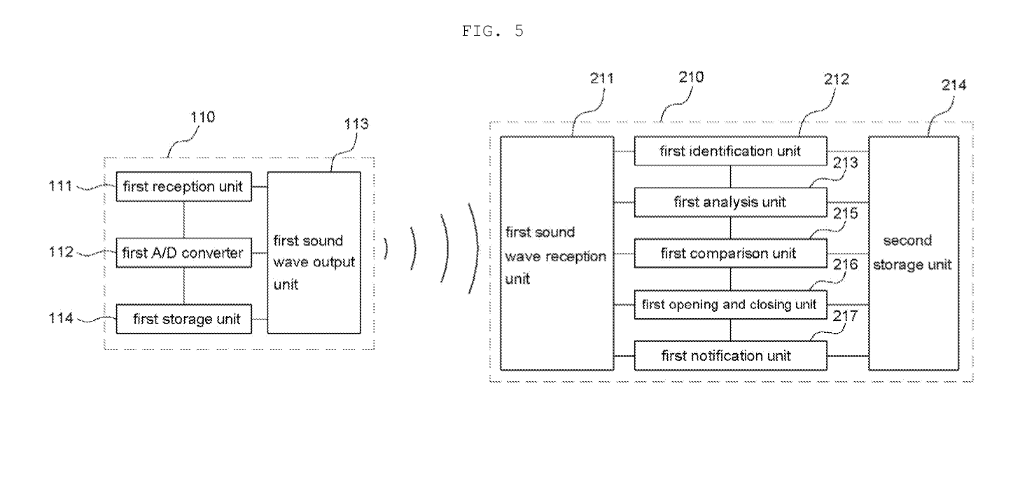

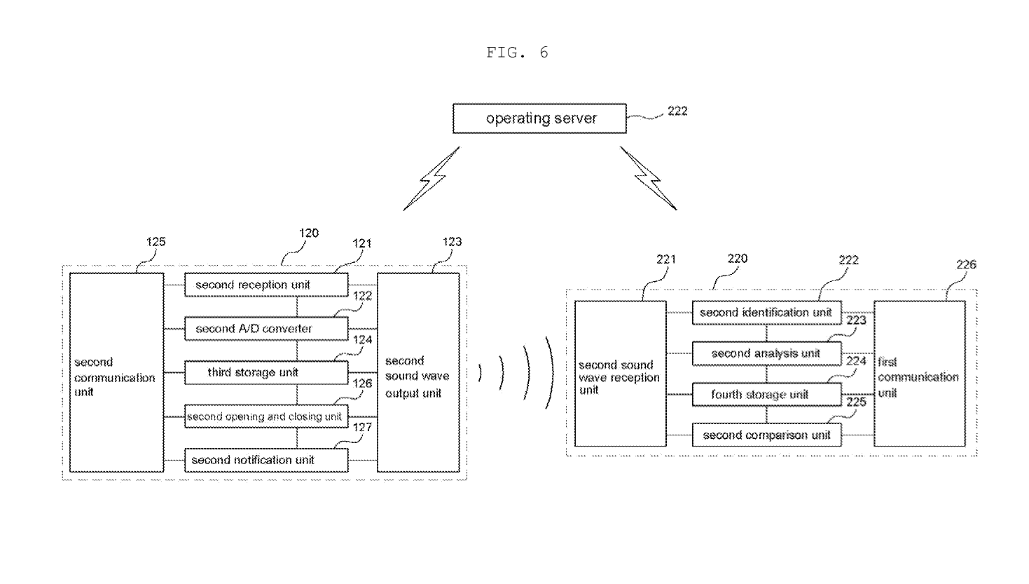

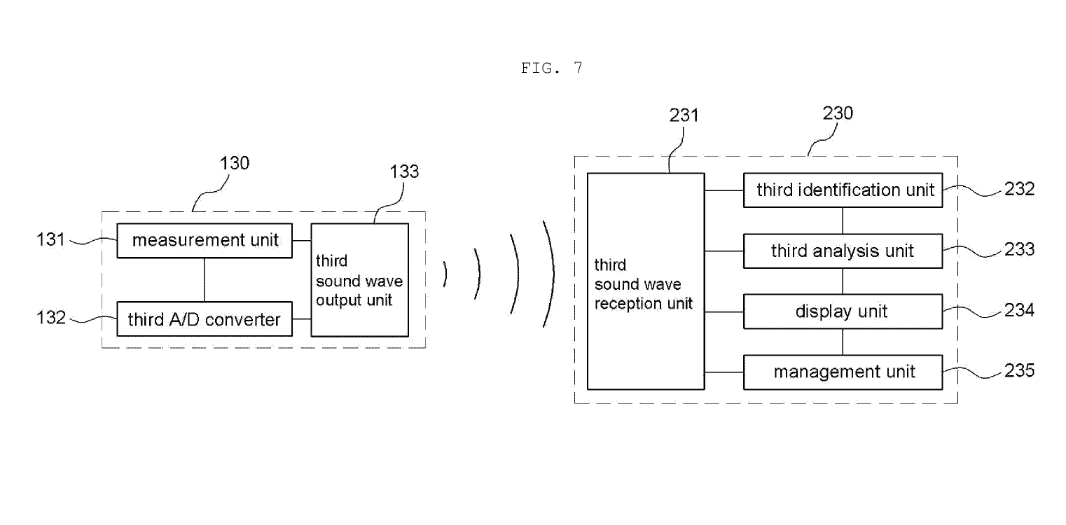

A digital locking system using a wireless sound wave communication system according to the present invention will be described with reference to FIGS. 4 to 6. FIG. 4 is a diagram illustrating a digital locking system using the wireless sound wave communication system according to the present invention. FIG. 5 is a diagram illustrating the configuration of a digital locking system according to a first embodiment of the present invention. FIG. 6 is a diagram illustrating the configuration of a digital locking system according to a second embodiment of the present invention.

Referring to FIG. 4, the digital locking system using a wireless sound wave communication system includes a digital door lock 210 disposed on the inside of a door 310 and a terminal rest 410 disposed on the outside thereof and configured to rest a terminal 110 thereon. Furthermore, a hole 510 is formed through the door 310 so that sound waves (sounds) generated by the terminal 110 or digital door lock 210 can be transmitted through the door 310.

FIG. 5 illustrates the digital locking system according to the first embodiment of the present invention. A first terminal 110 corresponds to the transmitter 100, while a first digital door lock 210 corresponds to the receiver 200.

The first terminal 110 may include a first reception unit 111, a first A/D converter 112, a first sound wave output unit 113, and a first storage unit 114. The first reception unit 111 receives password information from a user.

In this case, the first reception unit 111 is formed of a device capable of receiving information through a user's push or touch manipulation, such as a touch panel or a keyboard.

The first A/D converter 112 converts password information (number or letter information) set as needed and entered through the first reception unit 111 by the user into binary signals (digital signals).

The first sound wave output unit 113 generates the resulting binary signals as sound wave signals, and outputs the sound wave signals. In this case, in order to output the binary signals as the sound waves, the digital signals are converted into the analog signals and output as sound waves.

The first storage unit 114 stores the password information that is set as needed and entered by the user.

The first digital door lock 210 may include a first sound wave reception unit 211, a first identification unit 212, a first analysis unit 213, a second storage unit 214, a first comparison unit 215, a first opening and closing unit 216, and a first notification unit 217.

The first sound wave reception unit 211 receives the sound wave signal from the first terminal 110. A device that receives sound wave signals may be a microphone or the like.

The first identification unit 212 identifies frequency information corresponding to the received sound wave signals by analyzing the received sound wave signals. The frequency information of the recorded sound wave signals may be identified by Sample Rate Conversion (SRC).

The first analysis unit 213 arranges the identified frequency information in time sequence, and analyzes data based on areas that are extracted by the integration of the arranged frequency information. In this case, Fast Fourier Transform (FFT) may be used to extract the frequency areas.

The second storage unit 214 stores the password information that is set as needed.

The first comparison unit 215 compares the data analyzed by the first analysis unit 213 with the password information stored in the second storage unit 214.

The first opening and closing unit 216 includes at least one means for opening the door 310 if the data analyzed by the first analysis unit 213 matches the password information stored in the second storage unit 214. A locking device using a motor or a locking device using an electromagnet may be used as an opening and closing means.

The first notification unit 217 includes at least one notification means for notifying the user of an alarm if the data analyzed by the first analysis unit 213 does not match the password information stored in the second storage unit 214. In this case, the notification means may be a notification means for notifying the user of an alarm in a visual or aural manner. For example, the notification means may be an on-and-off light that can be visually recognized, a display that can issue a warning message, or a siren, a warning sound generator, or a speaker that can be aurally recognized.

The digital locking system according to the first embodiment operates in automatic mode and in manual mode.

### Automatic Mode

Password information that is set by a user as needed is stored in the first digital door lock 210 and the first terminal 110. When an operation button provided on the first digital door lock 210 is pressed in sleep mode (standby mode), the first digital door lock 210 switches to a mode in which sound waves generated by the first terminal 110 can be received. In this case, a method of switching to a mode in which sound waves generated by the first terminal 110 is not limited to pressing the operation button. As an example, it may be possible for the first digital door lock 210 to automatically receive and record sound wave signals when the first terminal 110 outputs the sound wave signals. This is a signal reception mode operation. Once the signal reception mode has been entered, a signal request message requesting password information is transmitted to the first terminal 110. In this case, a method of transmitting a signal request message to the first terminal 110 may be a method of automatically transmitting a signal request message to the first terminal 110 when the first terminal 110 is recognized by a sensor disposed in the door lock system. Furthermore, the first terminal 110 may receive the signal request message over a communication network. Accordingly, the first terminal 110 should include a communication unit (not illustrated) configured to receive the signal request message over a communication network, and the first digital door lock 210 should include a communication unit (not illustrated) configured to transmit the signal request message requesting the transmission of sound waves (sounds) to the first terminal 110.

Thereafter, when receiving the signal request message transmitted by the first digital door lock 210, the first terminal 110 generates and outputs password information converted into binary signals in the form of sound wave signals. Thereafter, the first digital door lock 210 receives the transmitted sound wave signals from the first terminal 110. When receiving the sound wave signals, the first digital door lock 210 identifies the frequency information corresponding to the sound wave signals by analyzing the received sound wave signals. Furthermore, the identified frequency information is arranged in time sequence, and data is analyzed based on areas that are extracted by the integration of the arranged frequency information. The first digital door lock 210 compares the analyzed data with the password information stored in the second storage unit 214. If, as a result of the comparison, it is determined that the analyzed data matches the password information stored in the second storage unit 214, the door 310 is opened. In contrast, if the analyzed data does not match the password information stored in the second storage unit 214, the first notification unit 217 operates such that a user can be notified of an alarm.

### Manual Mode

Password information that is set by a user as needed is stored in the first digital door lock 210 and the first terminal 110. Thereafter, a connection program (for example, an app that can be used in a smart phone) including a password algorithm installed in the first terminal 110 is executed. Once the connection program has been executed, the password information set by the user as needed is entered to the first terminal 110. The password information may be entered via a touch screen or input buttons that are provided in the first terminal 110. Furthermore, if the first terminal 110 contains a voice recognition program, the password information may be entered through voice recognition. Thereafter, the entered input password information (number or character information) is converted into binary signals (for example, digital signals). The resulting binary signals are generated and output in the form of sound wave signals. Thereafter, the first digital door lock 210 receives sound wave signals from the first terminal 110. Once the sound wave signals have been received, the first digital door lock 210 identifies frequency information corresponding to the sound wave signals by analyzing the received sound wave signals. Furthermore, the identified frequency information is arranged in time sequence, and then data is analyzed based on areas that are extracted by the integration of the arranged frequency information. The first digital door lock 210 compares the analyzed data with the password information stored in the second storage unit 214. If, as a result of the comparison, it is determined that the analyzed data matches the password information stored in the second storage unit 214, the door 310 is opened. In contrast, if it is determined that the analyzed data matches the password information stored in the second storage unit 214, the first notification unit 217 is operated such that a user can be notified of an alarm.

FIG. 6 illustrates the digital locking system according to the second embodiment of the present invention. The second digital door lock 120 corresponds to the transmitter 100, while the second terminal 220 corresponds to the receiver 200. Furthermore, the digital locking system according to the second embodiment includes an operating server 300.

Referring to FIG. 6, the second digital door lock 120 may include a second reception unit 121, a second A/D converter 122, a second sound wave output unit 123, a third storage unit 124, a second communication unit 125, a second opening and closing unit 126, and a second notification unit 127.

The second reception unit 121 receives password information from a user. In this case, the second reception unit 121 is formed of a touch panel, a keyboard, or a keypad that can receive information through the user's push or touch manipulation.

The second A/D converter 122 converts password information (number or character information) set as needed and entered by the user via the second reception unit 121 into binary signals (digital signals).

The second sound wave output unit 123 generates and outputs the resulting binary signals in the form of sound wave signals. In this case, to output the binary signals in the form of sound waves, the digital signals are converted into analog signals, and are then output in the form of sound waves.

The third storage unit 124 stores the password information that is set as needed and entered by the user.

The second communication unit 125 receives an opening and closing information message from the operating server 300 over a communication network. In this case, the opening and closing information message is a message including information about opening and closing. The communication network is a wireless communication network, and may use a wireless local area network (LAN) and a mobile communication network that is provided by a mobile communication provider. For this purpose, the second communication unit 125 uses a wireless communication module that enables wireless short-range communication and mobile communication. The wireless communication module may be any one of wireless short-range communication modules, including Bluetooth, ZigBee, infrared communication and RFID communication modules; any one of Internet communication modules capable of access to a wireless LAN via Wi-Fi or a hot spot; or any one of mobile communication modules capable of access to a mobile communication network, such as W-CDMA, Wibro, HSDPA, Wimax and LTE modules.

The second opening and closing unit 126 includes at least one means for opening the door 310 if the opening and closing information message received from the operating server 300 includes information indicating that the data matches the password information. The means for opening the door 310 may be a locking device using a motor or a locking device using an electromagnet.

The second notification unit 127 includes at least one notification means for notifying the user of an alarm if the opening and closing information message received from the operating server 300 includes information that does not match the password. In this case, the notification means may be a notification means for notifying the user of an alarm in a visual or aural manner. For example, the notification means may be an on-and-off light that can be visually recognized, a display that can issue a warning message, or a siren, a warning sound generator, or a speaker that can be aurally recognized.

Continuing with FIG. 6, the second terminal 220 may include a second sound wave reception unit 221, a second identification unit 222, a second analysis unit 223, a fourth storage unit 224, a second comparison unit 225, and a first communication unit 226.

The second sound wave reception unit 221 receives the sound wave signal from the second terminal 220. A device that receives sound wave signals may be a microphone or the like.

The second identification unit 222 identifies frequency information corresponding to the received sound wave signals by analyzing the received sound wave signals. The frequency information of the recorded sound wave signals may be identified by SRC.

The second analysis unit 223 arranges the identified frequency information in time sequence, and analyzes the data based on areas that are extracted by the integration of the arranged frequency information. Once the frequency information has been identified, the second analysis unit 223 arranges the identified frequency information in time sequence, and analyzes data based on areas that are extracted by the integration of the arranged frequency information. In this case, FFT may be used to extract the frequency areas.

The fourth storage unit 224 stores the password information that is set as needed.

The second comparison unit 225 compares the data analyzed by the second analysis unit 223 with the password information stored in the fourth storage unit 224. Furthermore, after determining whether the analyzed data matches the password information, the second comparison unit 225 generates an opening and closing information message indicative of whether to open the second digital door lock 220. In this case, the opening and closing information message is a message including information about whether to open the second digital door lock 220 depending on whether the analyzed data matches the password information.

The first communication unit 226 transmits the opening and closing information message to the communication network through operating server 300. The communication network is a wireless communication network, and may use a wireless local area network (LAN) and a mobile communication network that is provided by a mobile communication provider. For this purpose, the second communication unit 226 uses a wireless communication module that enables wireless short-range communication and mobile communication in the same manner as the second communication unit 125.

The operating server 300 includes a communication means (not illustrated) for communicating with the first communication unit 226 and the second communication unit 125 over the communication network. When receiving the opening and closing information message from the first communication unit 226 and then transmitting the opening and closing information message to the second communication unit 125, the operating server 300 encrypts and then transmits the opening and closing information message. As an example of encryption and decryption, it may be possible to encrypt data to be transmitted and decrypt received data using public keys, including encryption and decryption keys. In the encryption and decryption method using public keys, a secure opening and closing information message is generated by encrypting an opening and closing information message using the encryption key, and is then transmitted. Thereafter, the second digital door lock 120 decrypts the received encrypted opening and closing information message using the decryption key. In this case, the method of encrypting and decrypting an opening and closing information message is not limited to the method using encryption and decryption keys, but various data encryption methods that are available online may be used as the method of encrypting and decrypting an opening and closing information message.

The digital locking system according to the second embodiment operates as follows.

First, password information that is set by a user as needed is stored in the second digital door lock 120 and the second terminal 220. To start operation in the sleep mode (standby mode) of the second digital door lock 120, the second terminal 220 is brought close to the terminal rest 410 provided in the digital locking system or to a specific location. When the second terminal comes close to the terminal rest 410 or specific location, the second digital door lock 120 generates and outputs password information converted into binary signals in the form of sound wave signals. This is a signal output mode operation. In this case, a method of triggering a signal output mode operation is not limited to bringing the second terminal close to the terminal rest provided in the digital locking system or a specific location. As an example, it may be possible to output sound wave signals by pressing a specific operation button provided in the second digital locking system.

It may be possible to automatically receive and record sound wave signals when the second terminal 220 approaches the terminal rest or specific location. This is a signal reception mode operation. As an example of the signal reception mode, it may be possible to automatically operate in signal reception mode when the second terminal 220 is detected by a sensor provided in the digital locking system.

Once the signal reception mode has been entered, the second terminal 220 receives and stores sound wave signals output from the second digital door lock 120. After storing the sound wave signals, the second terminal 220 identifies frequency information corresponding to the stored sound wave signals by analyzing the stored sound wave signals. Furthermore, the identified frequency information is arranged in time sequence, and then data is analyzed based on areas that are extracted by the integration of the arranged frequency information. The second terminal 220 compares the analyzed data with the password information stored in the fourth storage unit 224. After the comparison, the second terminal 220 transmits an opening and closing information message to the operating server 300 over the communication network. In this case, the opening and closing information message is a message including information about whether to open the door 310 depending on whether the analyzed data matches the password information.

Thereafter, the operating server 300 transmits the received opening and closing information message to the second digital door lock 120.

The second digital door lock 120 determines whether to open the door 310 based on the received opening and closing information message. If the opening and closing information message includes information indicating the data matches the password information, the door 310 is opened. In contrast, if the opening and closing information message includes information indicating that the data does not match the password information, the second notification unit 127 is operated such that a user can be notified of an alarm.

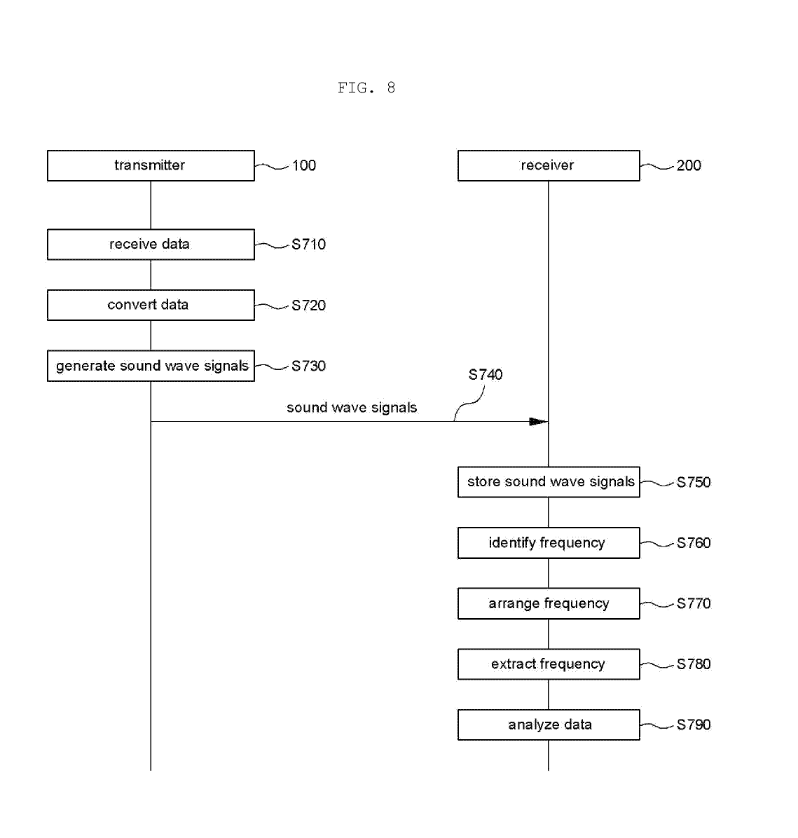

A health measurement system using the wireless sound wave communication system according to the present invention will be described with reference to FIG. 7. FIG. 7 is a diagram illustrating the configuration of the health measurement system using the wireless sound wave communication system according to the present invention. In this case, the health measurement apparatus 130 corresponds to the transmitter 100, while the third terminal 230 corresponds to the receiver 200.

The health measurement apparatus 130 includes a measurement unit 131, a third A/D converter 132, and a third sound wave output unit 133.

The measurement unit 131 includes at least one sensor that measures health information. The sensor that measures health information is defined depending on the type of health measurement apparatus 130. If the health measurement apparatus 130 is weight scales, the measurement unit 131 includes one or more load sensors. Alternatively, if the health measurement apparatus 130 is an obesity measurement apparatus, the measurement unit 131 includes one or more load sensors and one or more height measurement sensors. Alternatively, if the health measurement apparatus 130 is a biometric apparatus, such as a cardiotachometer, a blood pressure gauge, or a blood glucose meter, the measurement unit 131 includes one or more cardiotachometric sensors, blood pressure sensors, or blood glucose sensors. Alternatively, if the health measurement apparatus 130 is exercise equipment, such as a treadmill, an exercise bike, dumbbells, or a chest expander, the measurement unit 131 includes one or more of a variety of sensors that are capable of measuring an exercise state and calculating the amount of exercise. Accordingly, the measurement unit 131 according to the present invention may perform measurement via one or more sensors that measure body information, biometric information, or information about the amount of exercise.

The third A/D converter 132 converts signals measured by the measurement unit 131 into binary signals. The binary conversion of signals measured by the measurement unit 131 (for example, into digital signals) is performed by the third A/D converter 132. For example, if the measurement unit 131 includes a load sensor, the measurement unit 131 acts a device whose resistance value varies depending on the weight of the body, and the third A/D converter 122 converts the degree of variation in the resistance value into binary signals.

The third sound wave output unit 133 generates and outputs sound wave signals corresponding to the binary signals. The third sound wave output unit 133 includes at least one means for outputting sound waves. It is most preferable to use a speaker as the means for outputting sound waves.

The third terminal 230 includes a third sound wave reception unit 231, a third identification unit 232, a third analysis unit 233, a display unit 234, and a management unit 235.

The third sound wave reception unit 231 receives sound wave signals from the third terminal 230. A device that receives sound wave signals may be a microphone or the like. In this case, the third terminal 230 may be seated on the health measurement apparatus 130 and receive signals, or may receive sound wave signals over a predetermined distance. Accordingly, the sound wave signals are transferred to the third sound wave reception unit 231 of the third terminal 230.

The third identification unit 232 identifies frequency information corresponding to the received sound wave signals by analyzing the received sound wave signals. The sound wave signals received by the third sound wave reception unit 231 are transmitted to the third identification unit 232, and frequency information corresponding to the sound wave signals is identified. The frequency information of the recorded sound wave signals may be identified by SRC. In this case, the frequency information is divided into pieces of information about a preparation step, a start step, data, and a termination step. As described above, the preparation step frequency provides the time for which the third terminal 230 prepares the reception of sound wave signals. This can overcome the problem of missing sound wave signals because of the difference between the time at which the health measurement apparatus outputs sound wave signals after measuring health information and the time at which the third terminal 230 enters signal reception mode. Furthermore, the data can be accurately analyzed using the start and termination steps.

The third analysis unit 233 arranges the identified frequency information in time sequence, and analyzes the data based on areas that are extracted by the integration of the arranged frequency information. That is, once the frequency information has been identified, the third analysis unit 233 arranges the identified frequency information in time sequence, and analyzes the data based on areas that are extracted by the integration of the arranged frequency information. In this case, FFT may be used to extract the frequency areas.

The management unit 235 manages measured data in a cumulative manner, and generates body management information based on the cumulative measured data. The management unit 235 may give advice on a daily caloric requirement, an appropriate weight, a body fat adjustment, a muscle mass adjustment, exercise, or the like in the form of text information or graphical information based on the measured data that is managed in a cumulative manner. The body management information may be stored in a storage unit (not illustrated), or may be received from the operating server.

The display unit 234 includes at least one means for displaying the information that is analyzed by the third analysis unit 233. The display unit 234 displays the data analyzed by the third analysis unit 233 on the screen of the third terminal 230. The display is a combination of text information and graphical information, and provides a visual image of the results of the detection.

With reference to FIG. 8, a wireless sound wave communication method according to the present invention will be described. FIG. 8 is a flowchart illustrating the wireless sound wave communication method according to the present invention. Descriptions that have been given above will be omitted or given in brief. The following description may make the configuration of the wireless sound wave communication system of the present invention clearer.

Referring to FIG. 8, first, the transmitter 100 may measure data or receive input data from the outside at step S810. In this case, data may be measured using a device that can measure health information. Alternatively, data may be received through a user's push or touch manipulation. A means for receiving signals may be formed of a touch panel, a keyboard, or the like.

The transmitter 100 converts received data into binary signals at step S820. The binary signals are signals composed of “1” and “0” in the same manner as digital signals. Thereafter, the transmitter 100 converts binary signals into sound wave signals at step S830. The resulting sound wave signals are output to a device that can output sound waves, such as speaker, at step S840. In this case, the sound wave signals are uniformly output at intervals that are set by the user. Furthermore, to output sound wave signals, the binary signal (digital signals) are converted into analog signals and then output.

The receiver 200 receives and records the output sound wave signals at step S850. Frequency information corresponding to the sound wave signals is identified by analyzing the recorded sound wave signals at step S760. The frequency information corresponding to the recorded sound wave signals may be identified by SRC. In this case, SRC enables the frequency information to be identified by analyzing the sound wave signals in the form of analog signals. Thereafter, the receiver 200 arranges the identified frequency information in time sequence at step S870. The frequency information includes data about a preparation step, a start step, data, and a termination step, as can be seen from FIG. 2. Accordingly, data may be accurately analyzed by arranging frequencies corresponding to a preparation step, a start step, data, and a termination step. In this case, it is preferable that the start step frequency and the preparation step frequency be different frequencies. Furthermore, a predetermined frequency corresponding to the data frequency “1” and a predetermined frequency corresponding to “0” are used, and are output at the same intervals. The termination step frequency maintains a silent state for a period that is set as needed. The areas of the frequency information are extracted by the integration of the arranged frequency information at step S880. In this case, FFT may be used to extract the frequency areas. FFT is a method that calculates included frequency components and the sizes of the frequency components. The receiver 200 analyzes data based on the extracted areas at step S890. When specific data is analyzed based on an extracted area, the specific data is analyzed by being recognized as a binary bit. In this case, the recognition of a bit is performed in such a way that an integrated area in a normal state is set to a maximum value and a specific bit is recognized when the integrated area of the specific data is larger than the integrated area in a normal state by a ratio equal to or higher than a predetermined ratio. Furthermore, when “1” and “0” are recognized based on binary sound wave signals, data is recognized as “1” when the area of a region corresponding to “1” (in FIG. 4, a portion above reference line) is larger than the integrated area in a normal state by a ratio equal to or higher than the predetermined ratio. In contrast, data is recognized as “0” when the area of a region corresponding to “0” (in FIG. 3, a portion below the reference line) is larger than the integrated area in a normal state by a ratio equal to or higher than the predetermined ratio. As described above, data is recognized when an area in question is larger than the integrated area in a normal state by a ratio equal to or higher than the predetermined ratio normal state.

The wireless sound wave communication system and method according to the present invention have the advantages of transmitting and receiving data at low power and low cost because the transmitter outputs input data in the form of binary sound wave signals and the receiver receives and analyzes the output sound wave signals, thereby transmitting and receiving data via sound wave signals. Furthermore, the wireless sound wave communication system and method according to the present invention have the advantage of increasing the accuracy of analysis of data because upon analyzing received sound wave signals, the receiver identifies the frequency information of the sound wave signals and recognizes data through the integration of the identified frequency information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless sound wave communication system, comprising:
a transmitter configured to measure data or receive input data from an outside, to convert the data into binary signals, and to convert the binary signals into sound wave signals and then output the sound wave signals; and
a receiver configured to identify frequency information corresponding to the sound wave signals by receiving and analyzing the sound wave signals output from the transmitter, to arrange the identified frequency information in time sequence, and to analyze the data based on areas that are extracted by integration of the arranged frequency information;
wherein the sound wave signals that are output by the transmitter as the binary signals use different frequencies upon transmitting “0” and “1.”

2. The wireless sound wave communication system of claim 1, wherein the transmitter transmits information representative of a preparation step and information representative of a start step using different frequencies so that the receiver can be notified of the preparation and start steps when receiving the sound wave signals.

3. The wireless sound wave communication system of claim 1, wherein when the receiver analyzes the sound wave signals output as the binary signals, the receiver recognizes the sound wave signals as binary bits, and the recognition of the bits is performed in such a way that an integrated area in a normal state is set to a maximum value and a specific bit is recognized if each of the areas that are extracted by the integration of the frequency information corresponding to sound wave signals output as the binary signals is larger than the maximum value by a ratio equal to or higher than a predetermined ratio.

4. The wireless sound wave communication system of claim 1, wherein:
the transmitter is a first terminal, and the receiver is a first digital door lock;
the first terminal comprises:
a first reception unit configured to receive password information from an outside;
a first analog-to-digital (A/D) converter configured to convert the password information received from the first reception unit into binary signals;
a first sound wave output unit configured to generate and output sound wave signals corresponding to the binary signals; and
a first storage unit configured to store the password information;
the first digital door lock comprises:
a first sound wave reception unit configured to receive the sound wave signals output from the terminal;
a first identification unit configured to identify frequency information corresponding to the sound wave signals by analyzing the received sound wave signals;
a first analysis unit configured to arrange the identified frequency information in time sequence, and to analyze data based on areas that are extracted by integration of the arranged frequency information;
a second storage unit configured to store password information that is set as needed;
a first comparison unit configured to compare the data analyzed by the first analysis unit with the password information stored in the second storage unit;
a first opening and closing unit configured to include at least one means for opening a door if the data analyzed by the first analysis unit matches the password information stored in the second storage unit; and
a first notification unit configured to include at least one notification means for notifying a user of an alarm if the data analyzed by the first analysis unit does not match the password information stored in the second storage unit; and
the first terminal and the first digital door lock form a digital locking system.

5. The wireless sound wave communication system of claim 4, wherein the digital locking system comprises a hole formed through the door so that the sound wave signals generated by the terminal can be transmitted through the door, and a terminal rest formed on an outside of the door so that the terminal can be held therein.

6. The wireless sound wave communication system of claim 1, wherein
the transmitter is a second digital door lock, and the receiver is a second terminal;
the second digital door lock comprises:
a second reception unit configured to receive password information from an outside;
a second A/D converter configured to convert the password information received from the first reception unit into binary signals;
a second sound wave output unit configured to generate and output sound wave signals corresponding to the binary signals; and
a third storage unit configured to store the password information;
the second terminal comprises:
a second sound wave reception unit configured to receive the sound wave signals output from the second digital door lock;
a second identification unit configured to identify frequency information corresponding to the sound wave signals by analyzing the received sound wave signals;
a second analysis unit configured to arrange the identified frequency information in time sequence, and to analyze data based on areas that are extracted by integration of the arranged frequency information;
a fourth storage unit configured to store password information that is set as needed; and
a second comparison unit configured to compare the data analyzed by the second analysis unit with the password information stored in the fourth storage unit, and to generate an opening and closing information message including information about whether the data matches the password information; and
the second digital door lock and the second terminal form a digital locking system.

7. The wireless sound wave communication system of claim 6, wherein:
the second terminal further comprises a first communication unit configured to transmit the opening and closing information message to an operating server over a communication network; and
the second digital door lock further comprises:
a second communication unit configured to receive the opening and closing information message from the operating server;
a second opening and closing unit configured to include at least one means for opening a door if the opening and closing information message includes information indicating that the data matches the password information; and
a second notification unit configured to include at least one notification means for notifying a user if the opening and closing information message includes information indicating that the data does not match the password information.

8. The wireless sound wave communication system of claim 1, wherein:
the transmitter is a health measurement apparatus, and the receiver is a third terminal;
the health measurement apparatus comprises:
a measurement unit configured to include at least one sensor that measures health information;
a third A/D converter to convert signals measured by the measurement unit into binary signals; and
a third sound wave output unit configured to generate sound wave signals corresponding to the binary signals, and to output the sound wave signals;
the third terminal comprises:
a third sound wave reception unit configured to receive the sound wave signals from the health measurement apparatus;
a third identification unit configured to identify frequency information corresponding to the received sound wave signals by analyzing the received sound wave signal;
a third analysis unit configured to arrange the identified frequency information in time sequence, and to analyze the data based on areas that are extracted by integration of the arranged frequency information; and
a display unit configured to include at least one means for displaying information that is analyzed by the third analysis unit; and
the health measurement apparatus and the receiver form a health measurement system.

9. A wireless sound wave communication method, comprising:
measuring data or receiving input data from an outside;
converting the data into binary signals;
converting the binary signals into sound wave signals, and outputting the sound wave signals;
receiving and recording the output sound wave signals;
identifying frequency information corresponding to the stored sound wave signals by analyzing the received sound wave signals;
arranging the identified frequency information in time sequence;
extracting areas through integration of the arranged frequency information; and
analyzing the data based on the extracted areas.
